(19) United States
(12) Patent Application Publication
(10) Pub. No.: US 2019/0255618 A1
(43) Pub. Date: Aug. 22, 2019

(54) METHOD OF PROCESSING RARE EARTH MAGNET

(71) Applicant: TDK Corporation, Tokyo (JP)

(72) Inventors: Takeshi MASUDA, Tokyo (JP); Taeko TSUBOKURA, Tokyo (JP); Hiroshi MIYASAKA, Tokyo (JP); Yutaka HATAKEYAMA, Tokyo (JP); Toshihiro KUROSHIMA, Tokyo (JP)

(73) Assignee: TDK Corporation, Tokyo (JP)

(21) Appl. No.: 16/278,876

(22) Filed: Feb. 19, 2019

(30) Foreign Application Priority Data
Feb. 21, 2018 (JP) 2018-028518

(51) Int. Cl. B22F 3/24; H01F 41/02; H01F 1/08; C22C 30/02; B22F 3/16

(52) U.S. Cl. CPC B22F 3/24; H01F 41/0266; H01F 1/086; B22F 2301/355; B22F 3/16; B22F 2003/248; C22C 2202/02; C22C 30/02

(57) ABSTRACT

A method of processing a rare earth magnet comprises: a step of irradiating an R-T-B-based rare earth magnet with laser light to process; and a step of performing heat treatment on the magnet after the irradiating. The heat treatment includes: a step A of bringing the temperature of the magnet to 400° C. or less, a step B of holding the magnet at a temperature T1 in a range of 400 to 700° C. after the step A, and a step C of bringing the temperature of the magnet to less than 400° C. after the step B. The temperature of the magnet is made not to exceed 700° C. between the step A and the step B. The temperature of the magnet is made not to exceed 700° C. between the step B and the step C. A step of setting the magnet at a temperature higher than 700° C. after the step C is not included.

### TECHNICAL FIELD

The present invention relates to a method of processing a rare earth magnet mainly composed of rare earth element (R), transition metal element (T), such as Fe, and boron (B).

### BACKGROUND

As described in Patent Literature 1, a method of processing an R-T-B (R is one or more rare earth elements and T is a transition metal element such as Fe)-based rare earth magnet using laser light has been proposed.

### CITATION LIST

[Patent Literature 1] Japanese Unexamined Patent Publication No. 2009-732

### SUMMARY

However, the processing method using laser light having a specific wavelength disclosed in Patent Literature 1 may largely deteriorate the magnetic properties of a magnet after processing.

An object of the present invention, which has been made in view of the above-mentioned circumstances, is to provide a method of processing a rare earth magnet which suppresses deterioration in magnetic properties when processing is performed using laser light.

A method of processing a rare earth magnet according to the present invention, comprises: a step of irradiating an R-T-B-based rare earth magnet with laser light to process; and a step of performing heat treatment on the magnet after the irradiating.

The heat treatment includes:
a step A of bringing the temperature of the magnet to 400° C. or less,
a step B of holding the magnet at a temperature T1 in a range of 400 to 700° C. after the step A, and
a step C of bringing the temperature of the magnet to less than 400° C. after the step B.

The temperature of the magnet is made not to exceed 700° C. between the step A and the step B.

The temperature of the magnet is made not to exceed 700° C. between the step B and the step C.

The heat treatment does not include a step of setting the magnet at a temperature higher than 700° C. after the step C.

Here, the heat treatment may further include a step D of holding the magnet at a temperature T2 that is in a range greater than 400° C. and less than or equal to 1100° C. and is higher than the temperature T1, for a certain time before the step A.

Here, the certain time in the step B may range from one minute to 48 hours.

According to the present invention, magnetic characteristics deteriorated due to processing with laser light can be recovered.

### BRIEF DESCRIPTION OF THE DRAWINGS

FIGS. 1A to 1D present graphs showing a relationship between time and temperature in heat treatment according to an embodiment of the present invention;

FIGS. 2A to 2C present graphs showing a relationship between time and temperature in heat treatment not according to any embodiment of the present invention;

FIG. 3 presents perspective view of a magnet M1 before cutting, and a magnet M2 after cutting; and

FIG. 4 shows demagnetization curves related to magnets according to Example 1, Comparative Example 1, and Reference Example 1.

### DETAILED DESCRIPTION

A method of manufacturing a rare earth magnet according to an embodiment of the present invention will now be explained. Note that the present invention is not limited the embodiments below.

(R-T-B-Based Rare Earth Magnet)

An R-T-B-based rare earth magnet refers to a rare earth magnet containing one or more rare earth elements R, a transition metal element T, such as Fe, and boron B.

Rare earth elements refer to Sc, Y, and lanthanoid elements belonging to the third group of the long period type periodic table. Examples of lanthanoid elements include La, Ce, Pr, Nd, Sm, Eu, Gd, Tb, Dy, Ho, Er, Tm, Yb, and Lu.

It is preferable that T contain all of Fe, Co, and Cu. If Co is contained, the temperature characteristics can be improved without lowering the magnetic properties. In addition, if Cu is contained, the obtained magnet can have high coercive force, high corrosion resistance, and improved temperature characteristics. Examples of transition metal elements other than Fe, Co, and Cu include Ti, V, Cr, Mn, Ni, Zr, Nb, Mo, Hf, Ta, and W.

A magnet of this embodiment may further contain at least one element selected from the group consisting of, for example, N, Al, Ga, Si, Bi, and Sn in addition to R, T, and B. In addition, the R-T-B-based rare earth magnet may inevitably contain O, C, Ca, N, or the like. The content of each of them may be about 0.5 mass % or less.

The R-T-B-based rare earth magnet may be a sintered magnet, a hot-worked magnet, a rolled magnet, a current-sintered magnet, a metal bonded magnet.

The R-T-B-based rare earth magnet can have R₂T₁₄B grains (main phase), a two-grain boundary formed between the two adjacent R₂T₁₄B grains and a multiple-grain boundary surrounded by the three or more adjacent R₂T₁₄B grains. The average diameter of R₂T₁₄B grains can usually be in the range of about 1 to 30 μm.

(Method of Manufacturing R-T-B-Based Rare Earth Magnet)

First, as a starting material, a raw material alloy containing the elements contained in the R-T-B-based rare earth magnet is prepared (alloy preparation step). In the alloy preparation step, raw material metals corresponding to the composition of the R-T-B-based rare earth magnet are melted in a vacuum or in an inert gas atmosphere of an inert gas, such as Ar gas, and then casting is performed using it, thereby producing an alloy. In addition, the so-called two-alloy method may be used in which a first alloy forming a main phase and a second alloy mainly forming a grain boundary phase are prepared, and the alloys are pulverized and mixed.

Examples of the raw material metals include rare earth metals and rare earth alloys, pure iron, ferroboron, and alloys and compounds thereof. Examples of method of casting the alloy include the ingot casting method, the strip casting method, the book molding method, and the centrifugal casting method.

Next, the alloy is pulverized (pulverizing step). In the pulverizing step, the alloy is pulverized until its particle diameter becomes about several micrometers. Pulverization may be performed using hydrogen occlusion or a jet mill or the like.

Next, the alloy powder is molded into an intended shape to obtain a green compact (molding step). In the molding step, the alloy powder is loaded into a mold and then pressurized to be molded into an arbitrary shape. At this time, it is preferable that molding be performed while a magnetic field is applied so that the magnetic field application causes a specific alignment in the alloy powder to achieve molding in the magnetic field while the crystal axis is aligned. The green compact molded in the magnetic field has a crystal axis aligned in a specific direction and therefore has higher magnetic anisotropy.

The obtained green compact is sintered in a vacuum or an inert gas atmosphere, thereby producing an R-T-B-based sintered magnet (sintering step). The sintering temperature needs to be adjusted according to the composition, the pulverizing method, differences in particle size and particle size distribution, and other conditions. For example, the green compact is heated in a vacuum or in the presence of an inert gas at a temperature of 1000° C. to 1200° C. for one to ten hours for sintering. Thus, the mixed powder is liquid-phase sintered, thereby producing an R-T-B-based sintered magnet (sintered material) with an improved volume ratio of the main phase. It is preferable that after the green compact is sintered, the sintered material be rapidly cooled in order to improve the production efficiency.

The obtained R-T-B-based sintered magnet is held at a temperature lower than that during sintering, thereby performing aging treatment on the R-T-B-based sintered magnet (aging treatment step). For aging treatment, the treatment condition is adjusted as appropriate according to the number of times of performing aging treatment, for example, a two-stage heating having a heating stage at a temperature of 700° C. to 900° C. for one to three hours and a subsequent heating stage at a temperature of 500° C. to 700° C. for one to three hours, and a one-stage heating having a heating stage at a temperature around 600° C. for one to three hours. Such aging treatment can improve the magnetic properties of the R-T-B-based sintered magnet.

In the case where an R-T-B-based rare earth magnet other than a sintered magnet is manufactured, known hot working, rolling, or the like may be used instead of a sintering step.

The R-T-B-based rare earth magnet can be processed into a desired shape as needed (pre-processing step). Examples of processing method include machining, electrical discharge machining, ultrasonic machining, and barrel polishing.

The obtained R-T-B-based rare earth magnet is irradiated with laser light to process the R-T-B rare earth magnet (laser processing step). Examples of the processing include cutting, machining, groove formation, making a hole, cutout formation, gear cutting, and chamfering. Processing with laser light may be formation of a laser processing mark on the magnet that serves as a starting point of cleaving, breaking, and cracking.

After laser processing, the R-T-B-based rare earth magnet is subjected to heat treatment (heat treatment step).

The heat treatment includes:

a step A in which the temperature of the magnet is brought to 400° C. or less;

a step B in which the magnet is held at a temperature T1 in the range of 400 to 700° C. for a certain time after the step A; and

a step C in which the temperature of the magnet is brought to less than 400° C. after the step B.

Here, the temperature of the magnet is made not to exceed 700° C. between the step A and the step B.

Further, the temperature of the magnet is made not to exceed 700° C. between the step B and the step C.

Moreover, this heat treatment does not include a step that sets the magnet at a temperature higher than 700° C. after the step C.

There is no particular limitation on the time length of the step A as long as it contains a little time in which it is 400° C. or less. For example, a preferred time length is one minute to six hours.

If the temperature T1 in the step B is less than 400° C., Hk/Hcj is not recovered. The temperature T1 in the step B can be 650° C. or less. If the temperature T1 in the step B exceeds 700° C., Hcj greatly deteriorates. The certain time in which it is maintained at the temperature T1 in the step B can be one minute to 48 hours and can be set as appropriate in a range in which the magnetic properties can be recovered. When T1 is low within the above-mentioned range, the necessary heat treatment time tends to be long, and the production efficiency easily decreases. In contrast, when T1 is high within the above-mentioned range, the heat treatment time can be short but significant variations tend to occur in magnetic properties. The combination of T1 and the time in which T1 is maintained is preferably 400° C. to 600° C. and 10 minutes to 12 hours, more preferably 450° C. to 550° C. and 30 minutes to 6 hours.

There is no particular limitation on the time length of the step C, and it can be 10 minutes to 12 hours, for example.

The heat treatment can further include a step D in which the magnet is held at a temperature T2 that is in the range greater than 400° C. and less than or equal to 1100° C. and is higher than a temperature T1 for a certain time before the step A. The time in which it is held at the temperature T2 can be 10 minutes to 6 hours.

It is preferable that the temperature of the magnet be made not to exceed 1100° C. between the step A and the step D.

Further, it is preferable to provide a step in which the temperature of the magnet is brought to 400° C. before the step D and it is preferable that the temperature of the magnet be made not to exceed 1100° C. before the step D.

The step D may be performed more than once before the step A. In the case where the step D is performed more than once, a step in which the temperature of the magnet is brought to 400° C. or less can be provided between the two steps D.

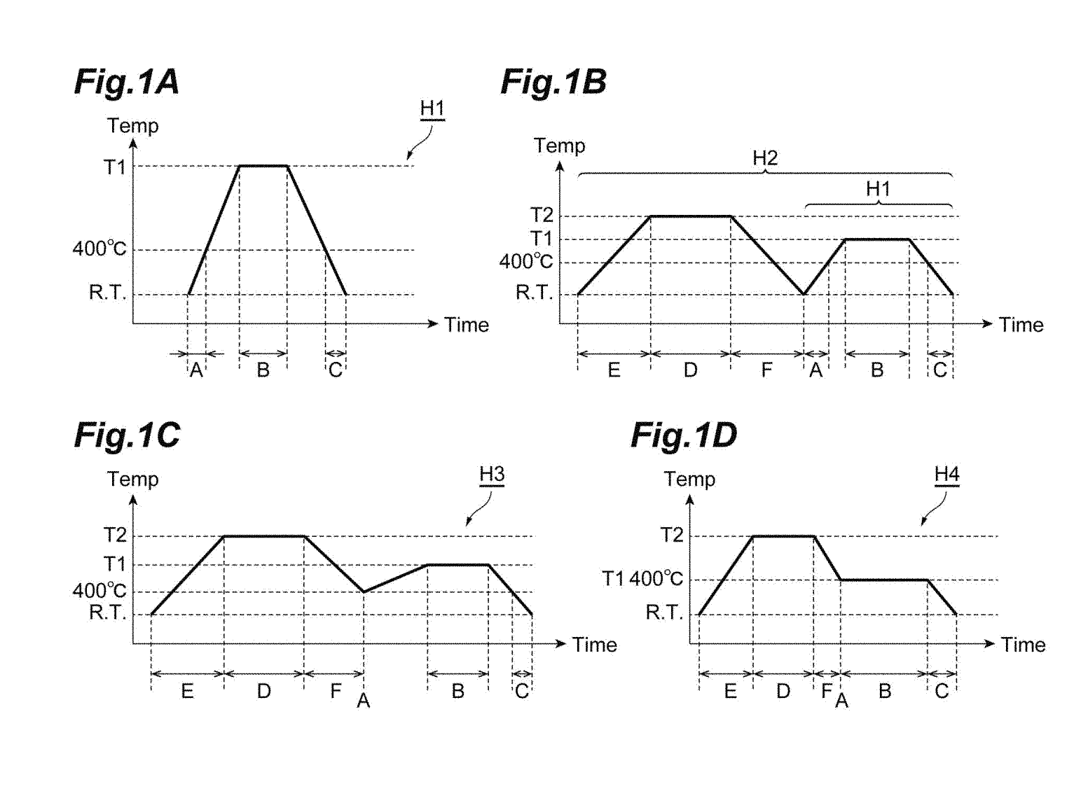

FIG. 1A shows a time-temperature pattern related to heat treatment H1 according to one example of this embodiment. In this heat treatment H1, the temperature linearly increases from room temperature (R.T.) to the temperature T1, is maintained at the temperature T1 for a certain time, and then linearly decreases to room temperature. Accordingly, as shown in FIG. 1A, the step A in which the temperature of the magnet is 400° C. or less, the step B in which the temperature of the magnet is held at the temperature T1 in the range of 400 to 700° C. for a certain time after the step A, and the step C in which the temperature of the magnet is brought to less than 400° C. after the step B are included in this order. In addition, the heat treatment H1 does not bring the temperature of the magnet at a temperature higher than 700° C. between the step A and the step B, does not bring the temperature of the magnet at a temperature higher than 700° C. between the step B and the step C, and does not include a step that brings the temperature of the magnet at a temperature higher than 700° C. after that the step C.

FIG. 1B shows a time-temperature pattern related to heat treatment H2 according to one example of this embodiment. This heat treatment H2 further includes a step E in which the temperature linearly increases from room temperature to the temperature T2 before the heat treatment H1, the step D in which the temperature is held at the temperature T2 for a certain time after the step E, and a step F in which the temperature linearly decreases from the step D to room temperature. As described above, the temperature T2 is a temperature in the range greater than 400° C. and less than or equal to 1100° C. and higher than the temperature T1.

FIG. 1C shows a time-temperature pattern related to heat treatment H3 according to one example of this embodiment. This heat treatment H3 differs from H2 in that the final temperature in the step F is 400° C. and the final point in the step F is thus also the step A.

FIG. 1D shows a time-temperature pattern related to heat treatment H4 according to one example of this embodiment. This heat treatment H4 differs from the heat treatment H3 in that the temperature T1 in the step B is 400° C. which is equal to the final temperature in the step F and the temperature in the step A.

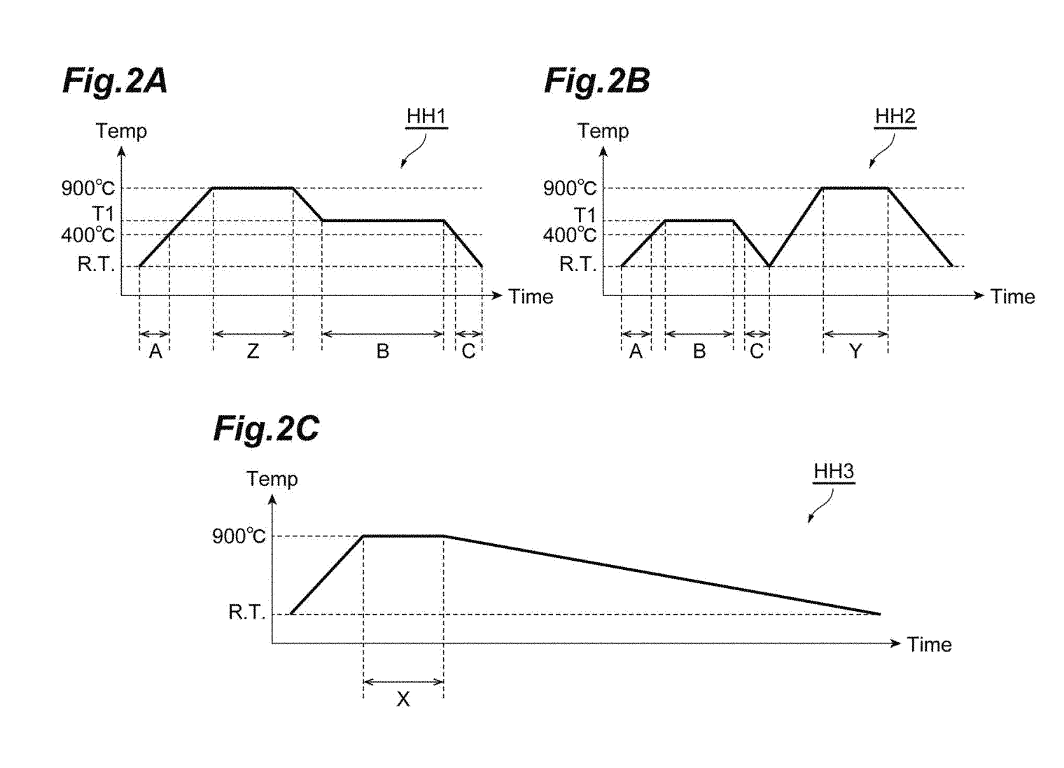

It should be noted that the heat treatment HH1 to HH3 shown in FIGS. 2A to 2C are not included in the embodiment of the present invention.

For example, the case of FIG. 2A, although the steps A to C are present, includes the step Z of bringing the temperature of the magnet to higher than 700° C. between the step A and the step B, and thus does not correspond to heat treatment of the embodiment.

The case of FIG. 2B, although the steps A to C are present, includes a step Y of bringing the temperature of the magnet to higher than 700° C. after the step C, and thus is not included in this embodiment.

Further, the step X in FIG. 2C gives high temperature and therefore is not included in the step B.

In addition, when this heat treatment step is suitable for aging treatment, after the sintering step, the aging treatment step before laser processing step can be omitted. In other words, the heat treatment step can also serve as an aging treatment step.

The magnet obtained through these steps may be subjected to surface treatment by plating, resin coating, oxidation treatment, chemical conversion treatment, or the like. This can improve the corrosion resistance of the magnet.

There is no particular limitation on the shape of the obtained magnet and it can have a columnar shape, such as a rectangular parallelepiped, a hexahedron, a flat plate, or a quadrangular prism, or an arbitrary shape, such as a C shape or a cylindrical shape in cross section. Similarly, there is no particular limitation on the size of the magnet.

When used as a magnet for a motor or other rotating machines, the magnet according to this embodiment, which as high corrosion resistance, can be used for a long period of time and exhibits high reliability. It is advantageous to use the magnet according to this embodiment as, for example, a magnet such as a surface permanent magnet (SPM) motor in which a magnet is attached to the rotor surface, an interior permanent magnet (IPM) motor in which a magnet is embedded in the rotor, or a permanent magnet reluctance (PRM) motor. To be specific, it is advantageous to use the magnet according to this embodiment for spindle motors and voice coil motors for rotative-driving of hard disks for hard disk drives, motors for electric cars and hybrid cars, motors for electric power steering of automobiles, servomotors of machine tools, motors for vibrators of mobile phones, motors for printers, motors for power generators.

(Effects)

If a rare earth magnet is processed with laser light, the structure of the portion (processed surface) where the laser light is incident is damaged, so that the magnetic characteristics are deteriorated. According to this embodiment, deteriorated magnetic characteristics can be recovered by heat treatment at an appropriate temperature.

### EXAMPLE

The present invention will now be described more in detail based on Example, but the present invention should not be limited to the following Example.

(Manufacture of Magnet)

First, a raw material alloy was prepared by strip casting so that a sintered magnet with the magnet composition (mass %) shown in Table 1 is obtained. It should be noted that in Table 1, bal. means the balance when the entire magnet composition is 100 mass %, and R_{L} represents the total mass % of Nd and Pr which are light rare earth elements.

TABLE 1

| | Nd | Pr | R_{L} | Co | Al | Cu | Zr | B | Fe |
|---|---|---|---|---|---|---|---|---|---|
| Magnet | 23.6 | 7.4 | 31.0 | 2.0 | 0.2 | 0.2 | 0.15 | 0.98 | bal. |
| composition | | | | | | | | | |

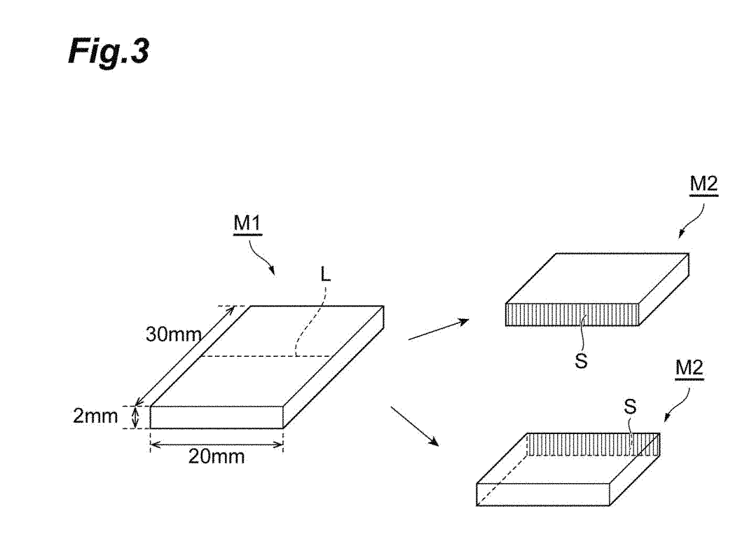

Next, raw material alloy was subjected to occlusion of hydrogen at room temperature, and then to hydrogen pulverizing treatment (rough pulverization) under Ar atmosphere at 600° C. for one hour for dehydrogenation. Afterwards, fine pulverization was performed using a jet mill, thereby providing fine-pulverized powder with an average particle diameter of about 4.0 μm. The obtained fine-pulverized powder was loaded into a mold and was then subjected to in-magnetic-field molding in which a pressure of 120 MPa was applied while a magnetic field of 1200 kA/m was applied, thereby producing a green compact. Subsequently, the obtained green compact was held in a vacuum at 1060° C. for four hours (in a vacuum), at 850° C. for one hour (under Ar atmosphere), and at 540° C. for two hours (under Ar atmosphere) to produce magnets having the composition shown in Table 1. The obtained magnet M1 measured 30 mm by 20 mm and had a thickness of 2 mm as shown in FIG. 3.

(Magnet Processing)

Each magnet M1 was cut along the dotted line L shown in FIG. 3 by fiber laser. The two magnet pieces M2 obtained by cutting have approximately the same size. Table 2 shows the conditions of the fiber laser that was used. Thus, the magnet pieces used in Example and Comparative Example were obtained.

TABLE 2

| Laser | Laser | Fiber | | Processing | Assist gas | Head gas | Processing |
|---|---|---|---|---|---|---|---|
| method | wavelength | diameter | Output | speed | type | pressure | length |
| Continuous | 1080 nm | 35 μm | 600 W | 100 mm/min | Nitrogen | 1.2 MPa | 20 mm |

### Example 1

The magnet piece obtained by cutting with fiber laser was subjected to heat treatment (under Ar atmosphere) using the heat treatment pattern shown in FIG. 1B. To be specific, T2=900° C., the time of T2 was set to one hour, T1=500° C., and the time of T1 was set to one hour. The room temperature was 23° C.

### Comparative Example 1

The magnet piece obtained by cutting with fiber laser was not subjected to any heat treatment.

### Reference Example 1

As a reference of magnetic properties, a magnet piece according to Reference Example was also prepared by cutting the magnet M1 by machining (a diamond wheel) instead of laser processing along the dotted line L shown in FIG. 3.

(Evaluation)

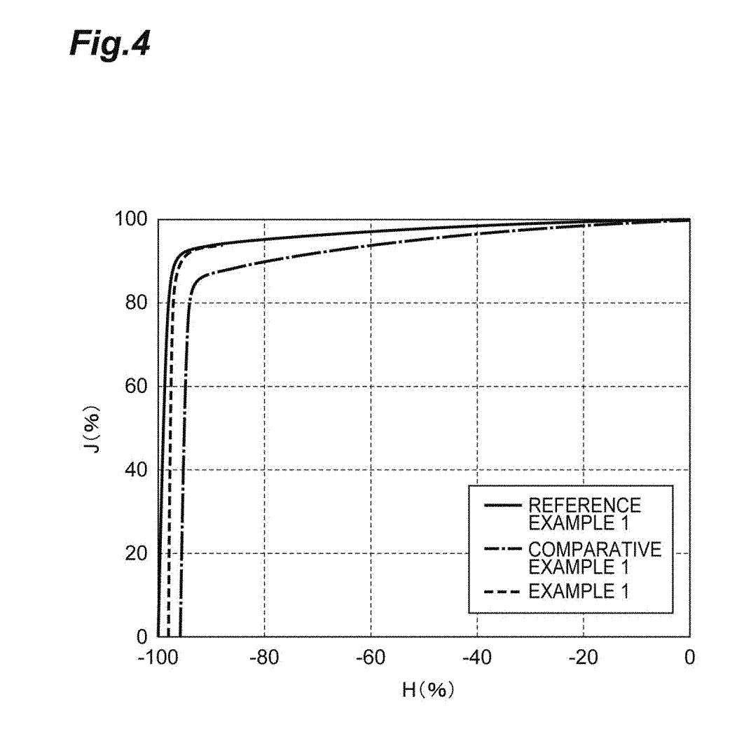

Six magnet pieces of each of Example 1, Comparative Example 1, and Reference Example 1 were stacked together such that the laser-cut surface S is exposed on one face, and the magnetic properties were measured in the vicinity of the exposed surface of the laser-cut surface S by using a BH tracer. FIG. 4 shows the demagnetization curves, and Table 3 shows the main magnetic properties. Each value is a relative value normalized assuming that the magnetic property obtained by machining (without laser processing) is 100. Regarding Comparative Example 1 (without heat treatment after laser processing), all the magnetic properties shown in Table 3 are more deteriorated than those in Reference Example 1 (machining); in particular, Hk/Hcj is deteriorated by 10% or more. In contrast, in the case of Example 1 (with heat treatment at 500° C. after laser processing), all the magnetic properties are higher than those in Comparative Example 1, and the magnetic property is recovered from that in Reference Example by a percentage as high as 98% or more.

TABLE 3

| | Br (%) | Hcj (%) | (BH)max (%) | Hk/Hcj (%) |
|---|---|---|---|---|
| Reference | 100% | 100% | 100% | 100% |
| Example 1 | | | | |
| Comparative | 99% | 96% | 98% | 88% |
| Example 1 | | | | |
| Example 1 | 100% | 98% | 100% | 100% |

### Example 2

The magnet piece obtained by cutting with fiber laser was subjected to heat treatment (under Ar atmosphere) using the heat treatment pattern shown in FIG. 1A. To be specific, T1=500° C. and T1 was held for one hour. The room temperature was the same as in Example 1.

### Comparative Example 2

The magnet piece obtained by cutting with fiber laser was subjected to heat treatment (under Ar atmosphere) using the heat treatment pattern shown in FIG. 1A. To be specific, T1=800° C. and T1 was held for one hour. The room temperature was the same as in Example 1.

(Evaluation)

The magnetic properties of the magnet pieces according to Example 2 and Comparative Example 2 were measured in the same manner as in Example 1. Table 4 shows the main magnetic properties. In Comparative Example 2, Hcj, in particular, is deteriorated by 45% from that in Reference Example 1. In contrast, in Example 2, all the magnetic properties are recovered by a percentage as high as 96% or more from those in Reference Example.

TABLE 4

| | Br (%) | Hcj (%) | (BH)max (%) | Hk/Hcj (%) |
|---|---|---|---|---|
| Reference | 100% | 100% | 100% | 100% |
| Example 1 | | | | |
| Example 2 | 100% | 96% | 99% | 100% |
| Comparative | 103% | 55% | 106% | 101% |
| Example 2 | | | | |

What is claimed is:

1. A method of processing a rare earth magnet, the method comprising:
a step of irradiating an R-T-B-based rare earth magnet with laser light to process; and
a step of performing heat treatment on the magnet after the irradiating, the heat treatment including:
a step A of bringing the temperature of the magnet to 400° C. or less,
a step B of holding the magnet at a temperature T1 in a range of 400° C. to 700° C. after the step A, and
a step C of bringing the temperature of the magnet to less than 400° C. after the step B, wherein
the temperature of the magnet is made not to exceed 700° C. between the step A and the step B,
the temperature of the magnet is made not to exceed 700° C. between the step B and the step C, and
the heat treatment does not include a step of setting the magnet at a temperature higher than 700° C. after the step C.

2. The method according to claim 1, wherein the heat treatment further includes a step D of holding the magnet at a temperature T2 that is in a range greater than 400° C. and less than or equal to 1100° C. and is higher than the temperature T1, for a certain time before the step A.

3. The method according to claim 1, wherein the certain time in the step B ranges from one minute to 48 hours.

4. The method according to claim 2, wherein the certain time in the step B ranges from one minute to 48 hours.
